(19) United States
(12) Patent Application Publication
(10) Pub. No.: US 2002/0034972 A1
(43) Pub. Date: Mar. 21, 2002

(54) Operating device which is to be fastened to a component

(76) Inventors: Peter Verbeek, St. Nom La Breteche (FR); Stephane Melou, Rambouillet (FR); Bruno Aubert, Epernon (FR)

Correspondence Address: Richard A. Speer, MAYER, BROWN & PLATT, P.O. Box 2828, Chicago, IL, 60690-2828, US

(21) Appl. No.: 09/813,404

(22) Filed: Mar. 20, 2001

(30) Foreign Application Priority Data
Apr. 4, 2000 (EP) 00 107 276.8

(51) Int. Cl. H04M 1/00

(52) U.S. Cl. 455/569; 455/345; 455/92

(57) ABSTRACT

An operating device (1) is designed for fastening to a component which is circular in cross section, for example a steering-wheel rim or a steering-wheel spoke. For this purpose, two strap parts (6, 9) which are to be connected to each other are fitted to the operating device (1) for wrapping around the component. One strap part (6) is provided with a clamping lever (3) for pivoting it into a position beyond the dead center in which the strap parts (6, 9) are in a clamping position.

### BACKGROUND OF THE INVENTION

The invention relates to an operating device, in particular for a car radio, which is to be fastened to a component which is at least approximately circular in cross section, for example a steering-wheel rim or a steering-wheel spoke.

There has recently been a shift to arranging operating buttons on the steering wheel of a motor vehicle enabling a person to operate a car radio or a vehicle navigation system, for example, without having to move his hands a great distance away from the steering wheel. In new vehicles operating buttons of this type can be integrated in the steering wheel. If it is desired to retrospectively provide an existing vehicle with the equivalent operating convenience, a separate operating device has to be fastened to the steering wheel using rubber bands or clamping clips, for example, which is awkward and not very reliable.

The invention is based on the problem of designing an operating device, which is to be fastened to a component, in particular a steering wheel, in such a manner that the fastening can take place rapidly and reliably without a tool being required for this.

The handling of the fastening means of the operating device is particularly simple if one strap part has a rack-like toothed arrangement on the inside, and the other strap part has a corresponding rack-like toothed arrangement on the outside and, in the vicinity of the clamping lever, has an aperture for pushing the other strap part through. Clamping parts of this type have already proven successful for ski boots.

The strap parts can be closed by always placing them tightly over the component on which the operating device is to be fastened, and then shifting the clamping lever without there being the risk of excessive tightening if, according to another development of the invention, the strap parts are of elastic design.

### DESCRIPTION OF THE DRAWINGS

The invention permits various embodiments. One of these is illustrated in the drawing and is described below. In the drawings,

FIG. 1 shows an operating device having open strap parts for fastening to a component,

FIG. 2 shows the operating device with overlapping strap parts,

FIG. 3 shows the operating device with closed, tightened strap parts, and

FIG. 4 shows a cross section through the operating device with tightened strap parts.

### DETAILED DESCRIPTION OF THE INVENTION

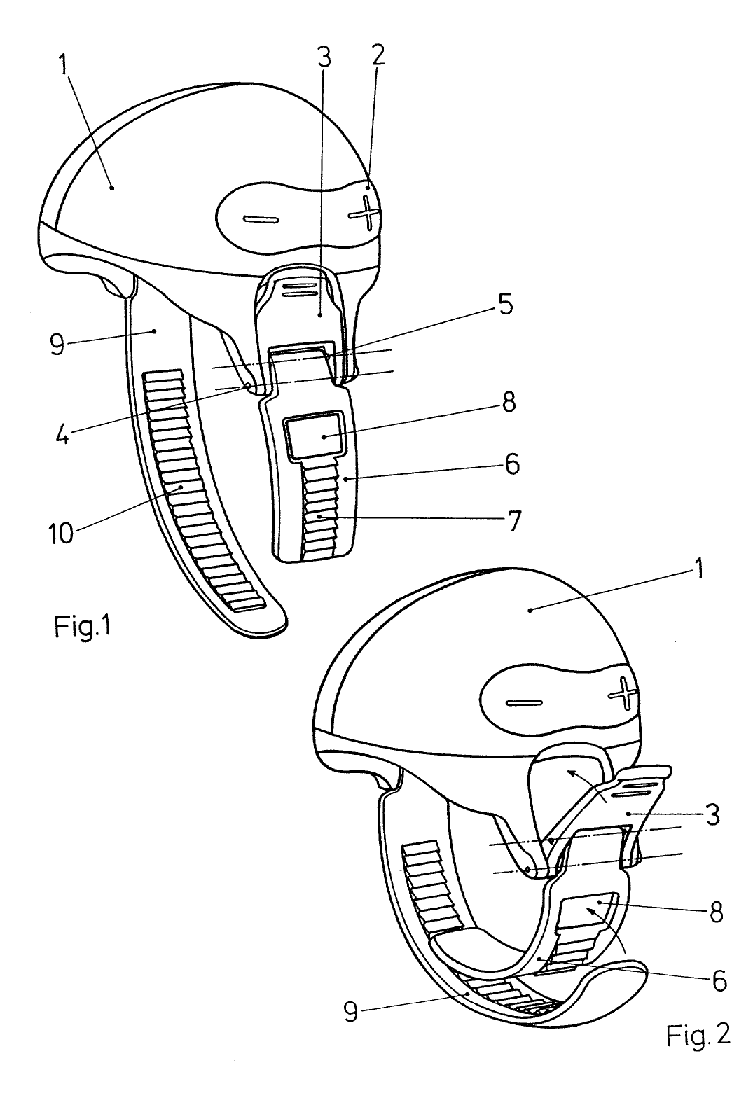

FIG. 1 shows an operating device 1 which has, on its front side, a toggle switch 2 with which, for example, a radio can be made louder or quieter. A clamping lever 3 is coupled to the lower side of the operating device 1 in a manner enabling it to pivot around a pivoting spindle 4. In the illustrated clamping position of the clamping lever 3, a spindle 5, to which a strap part 6 is fastened, runs parallel to the pivoting spindle 4. This strap part 6 has a rack-like toothed arrangement 7 on the outside and an aperture 8 in the vicinity of its clamping-lever end.

A second strap part 9, which has a toothed arrangement 10 on the inside which corresponds to the toothed arrangement 7, is likewise coupled to the lower side of the operating device 1.

FIG. 2 shows how, in order to fasten the operating device 1 on a component 11 (shown in cross section in FIG. 4), the strap part 9 is first of all guided over the strap part 6. In this case, the clamping lever 3, as seen in the figures, has been pivoted downwards. The end of the strap part 9 is then pushed through the aperture 8 until the strap parts 6, 9 rest tightly on the component 11 (not shown in FIG. 2).

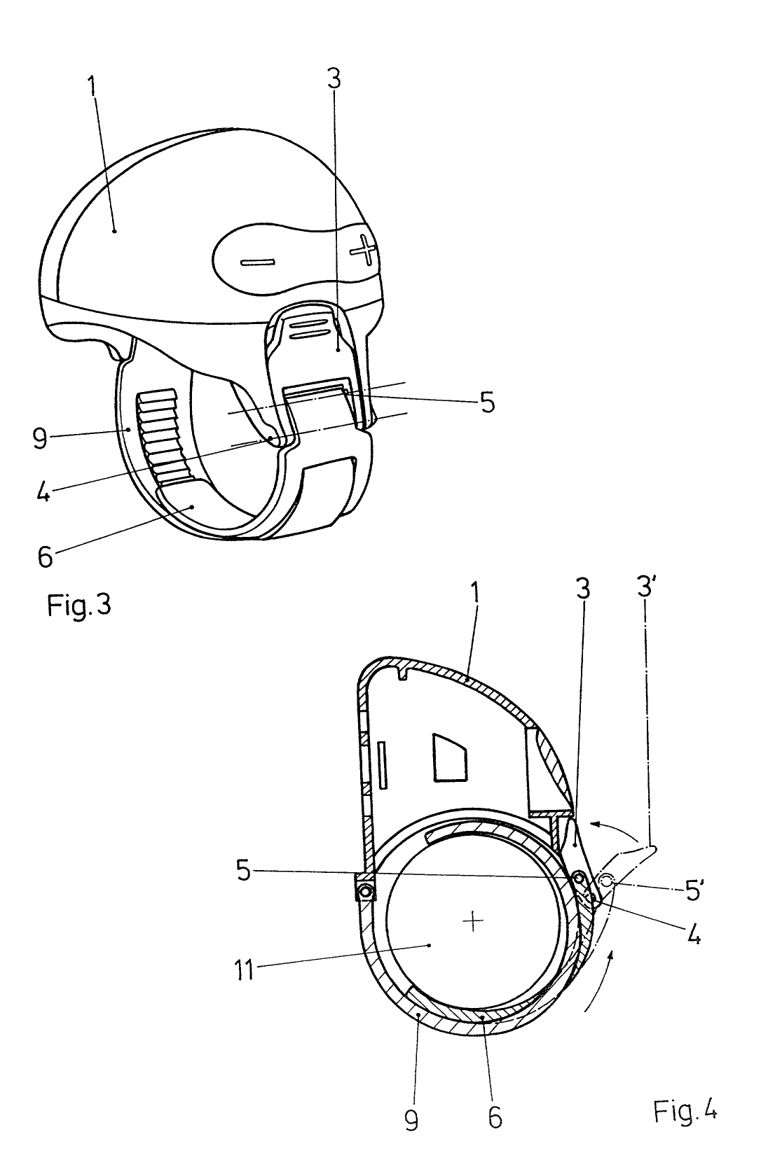

FIG. 3 shows that the two strap parts 6, 9 enter into a clamping position if the clamping lever 3 is moved back into the clamping position shown in FIG. 1. It can be seen that the spindle 5 is then located closer to the operating device 1 than in FIG. 2, thus resulting in the clamping stroke.

FIG. 4 makes it clear that the clamping lever 3 is able to pass together with its spindle 5 from a release position (illustrated by dashed-dotted lines) beyond a dead center into a clamping position in which the strap parts 6, 9 are clamped.

1. Operating device, in particular for a car radio, which is to be fastened to a component which is at least approximately circular in cross section, for example a steering-wheel rim or a steering-wheel spoke, characterized in that the operating device (1) has, for wrapping around the component (11), two strap parts (6, 9) which are to be connected to each other, and in that one strap part (6) is provided with a clamping lever (3) for pivoting it into a position beyond the dead center in which the strap parts (6, 9) are in a clamping position.

2. Operating device according to claim 1, characterized in that the clamping lever (3) is coupled to the operating device (1) by means of a pivoting spindle (4) and one strap part (6) is coupled to a spindle (5) of the clamping lever (3), which spindle runs parallel to the pivoting spindle (4), and in that the clamping lever (3) is of pivotable design enabling it to pivot around its pivoting spindle (4) from a clamping position, in which the spindle (5) is at minimal distance from the operating device (1), beyond a dead center into a release position, in which the spindle (5) is at a greater distance from the operating device (1).

3. Operating device according to claims 1 or 2, characterized in that one strap part (9) has a rack-like toothed arrangement (10) on the inside, and the other strap part (6) has a corresponding rack-like toothed arrangement (7) on the outside and, in the vicinity of the clamping lever (3), has an aperture (8) for pushing the upper strap part (9) through.

4. Operating device according to at least one of the preceding claims, characterized in that the strap parts (6, 9) are of elastic design.
